(19) United States
(12) Patent Application Publication
(10) Pub. No.: US 2010/0013117 A1
(43) Pub. Date: Jan. 21, 2010

(54) METHOD FOR THE MANUFACTURE OF A BUILDING PRODUCT

(76) Inventors: Bhushan Kumar Oberoi, Surrey (GB); Cassian Barber, West Sussex (GB)

Correspondence Address: OSTROLENK FABER GERB & SOFFEN, 1180 AVENUE OF THE AMERICAS, NEW YORK, NY, 100368403, US

(21) Appl. No.: 12/439,405

(22) PCT Filed: Sep. 1, 2006
(86) PCT No.: PCT/GB06/03239

§ 371 Date: Feb. 27, 2009

(51) Int. Cl. B28B 5/02; B28B 7/06

(52) U.S. Cl. 264/167; 425/224

(57) ABSTRACT

The method includes providing a rigid mould (8, 150) with at a re-entrant cavity (96, 196). Mouldable material is provided on the rigid mould and the re-entrant cavity is filled to form a hook-like protuberance (36) on a surface of the moulded building product to facilitate, in use, the attachment of the building product to the structure of a building. The mouldable material sets to form a building product. The building product is removed from the mould. The re-entrant cavity has a resilient portion to facilitate the removal of the building product without detrimental affect to the hook-like protuberance. The so-formed building products have a greater resistance to inclement weather conditions. The building product may be a concrete roof tile formed by a roller and slipper extrusion method, a clay tile made by pressing in a clay tile press, or a cast concrete roof tile.

This invention is concerned with improvements in or relating to a method and apparatus for the manufacture of a building product and is particularly, although not exclusively, concerned with improvements in the manufacture of a concrete roof tile by the well-known roller and slipper extrusion method.

In the manufacture of concrete roof tiles by the roller and slipper extrusion method, tile pallets are fed seriatim through a mortar hopper of a tile making plant whereat concrete tile mortar fed into the hopper is formed as a ribbon of extrudate overlying the tile pallets, which are configured to form an underside, in use, of the roof tiles, an upper-side of the roof tiles being formed by the roller and slipper.

Downstream of the hopper of the tile making plant, the ribbon of extrudate is cut to form discrete roof tiles on their associated pallets, which are thereafter fed to a curing chamber where the green-state roof tiles are cured in an atmosphere commensurate with achieving sufficient strength for enabling the de-moulding of the roof tiles from the pallets.

It will be appreciated that the underside of tiles formed in this way do not include any complicated geometry that might impair the de-moulding of the moulded and cured roof tiles; thus, while the tiles may be provided with hanging nibs by which they may be hung on roof battens in use, such hanging nibs are designed with positive draught angles to facilitate the de-moulding operation.

The hanging nibs of conventional concrete roof tiles are generally provided at or towards a head portion of the tile in use; such tiles being secured to a roof structure by fixings including nails and/or clips of many configurations depending upon the shape of the roof tile and the specified roof tile fixing instructions. Nails are used to fix the head portion of the tile, whilst clips are generally used to fix the under side lock towards the tail end of the tile in use.

Hitherto, such hanging nibs are generally formed with a contact surface that is formed at a right angle, or substantially so, to a longitudinal plane of a roof tile, which contact surface normally engages, in use, a rear surface of a conventional wooden roof batten that extends laterally across a roof structure.

The fixings by which roof tiles are secured to a roof structure are specified to ensure that, in use, the roof tiles will resist the most inclement weather conditions; thus, it is common practice for of roof tiles to be subjected to stringent wind uplift test regimes before being adopted for commercial usage in order to determine the resistance of the tiles to uplift at their tail end portions, i.e. the lower ends of the tiles, where the wind uplift force predominantly acts.

Alternative means for securing roof tile to a roof have been proposed, which alternative means have included hook-like elements of plastic or metal that are co-moulded with the roof tiles during the manufacture thereof. The said hook-like protuberances being located, in use, on conventional roof battens or prefabricated roof battens of timber, metal or plastic that may have any configuration commensurate with facilitating the attachment of the roof tiles to the roof structure.

The disadvantages of the alternative roof tile securing means are the added complexity in their methods of manufacture and the added costs of the plastic or metal elements that have to be pre-formed and accommodated securely in the pallets prior to the pallets being fed through a roof tile making machine where tile mortar is fed onto the pallets to form a ribbon of mortar as aforesaid.

It is, therefore, an object of the present invention to provide an improved method and apparatus for the manufacture of building products such as concrete roof tiles that overcomes or at least mitigates the disadvantages met hitherto.

Thus, in a first aspect, the present invention provides a method for the manufacture of a building product by:

(a) providing a rigid mould with at least one re-entrant cavity;
(b) providing mouldable material on the rigid mould and filling the at least one re-entrant cavity to form at least one hook-like protuberance on a surface of the moulded building product to facilitate, in use, the attachment of the building product to the structure of a building;
(c) allowing the mouldable material to set to form a building product; and,
(d) removing the building product from the mould, the re-entrant cavity thereof having a resilient portion to facilitate the removal of the building product without detrimental effect to the at least one hook-like protuberance.

In a second aspect the present invention provides a rigid mould for the production of a building product, the mould comprising at least one re-entrant cavity for use in forming a hook-like protuberance on the building product, the re-entrant cavity having a resilient portion to facilitate the removal of the building product from the mould without detrimental effect to the at least one hook-like protuberance.

The rigid mould according to the invention is preferably provided with a resilient portion which provides at least part of the re-entrant cavity. Preferably, the resilient portion is made from a flexible natural or synthetic material such as rubber, a plastics material, rubberised plastic or other resilient material inert to, and impervious to, the material from which the building product is formed.

Preferably, the resilient portion is in the form of an insert which defines said re-entrant cavity. The resilient portion may be provided by a rectangular insert for insertion into a complementarily shaped aperture in the mould, the insert being provided with a location means, for example a peripheral flange to prevent displacement of the insert relative to the mould when in use in forming the hook-shaped protuberance.

As an alternative, the resilient portion forms only a part of said re-entrant cavity. For example, the resilient portion forms the rear lip of said re-entrant cavity. In this embodiment, the resilient portion may be provided by an insert for insertion into a complementarily shaped aperture in the mould, the insert comprising a rigid backing member supporting said resilient portion. In an alternative version of this embodiment, the insert providing the resilient portion may be have no rigid backing member but be inserted directly into a complementarily shaped aperture in the mould.

In another embodiment such an insert may consist exclusively of a resilient material without any rigid backing member to support it. In this case the rigid backing member may be formed as an integral part of the mould.

Other configurations are possible in which an even larger part of the cavity is formed as an integral part of the mould and an even smaller part is formed by the resilient portion, the aim being to limit amount of the resilient material being used, which material is relatively expensive.

Preferably, the resilient portion of each rigid mould is provided towards an end thereof that forms a lower end, in use, of the building product.

In one convenient embodiment provided by the present invention the re-entrant cavity of the resilient portion is of substantially trapezium shape in sideways cross-section with a taper, albeit slight, in the direction into the cavity. This configuration of the cavity facilitates the forming of the hook-like protuberance on the building product and facilitates the ease with which a moulded building product is subsequently removed from the rigid mould.

Conveniently, each rigid mould comprises at least two re-entrant cavities for the formation of at least two hook-like protuberances on each building product.

The building product may be a roof tile, in which case the mould is in the form of a tile mould for production thereof.

For example, the building product is a concrete roof tile and the rigid mould is a conventional tile pallet for the production of concrete roof tiles by an extrusion process wherein tile pallets are passed seriatim beneath a hopper containing a cementitious composition, the hopper being provided with a roller and slipper for generating the upper surfaces, in use, of roof tiles, the method being further wherein, as the tile pallets pass beneath the hopper and the cementitious composition is fed onto the tile pallets, the re-entrant cavities of successive tile pallets are filled with the cementitious composition to form the hook-like protuberances on the underside, in use, of the roof tiles.

Preferably, the cementitious composition is a concrete mortar.

In another example the building product is a clay roof tile and the rigid mould is built into a conventional tile mould for use in a conventional clay tile making press wherein the tile moulds are presented beneath the press head of the tile making press, a green state ceramic composition is supplied into the mould and the press head is closed to form a clay roof tile with a hook-like protuberance being provided on the underside of the tile so formed. The green-state tile is then demoulded for drying and firing in a conventional manner.

In a further example the building product is a concrete roof tile made from a castable, cementitious composition and the rigid mould comprises two half-moulds wherein the half-mould forming an underside of the concrete roof tile is provided with at least one re-entrant cavity for forming, in use, at least one hook-like protuberance on an underside of the roof tile. In this instance the tile is demoulded after curing.

There now follows, by way of example of the invention, a detailed description, which is to be read with reference to the accompanying drawings in which:

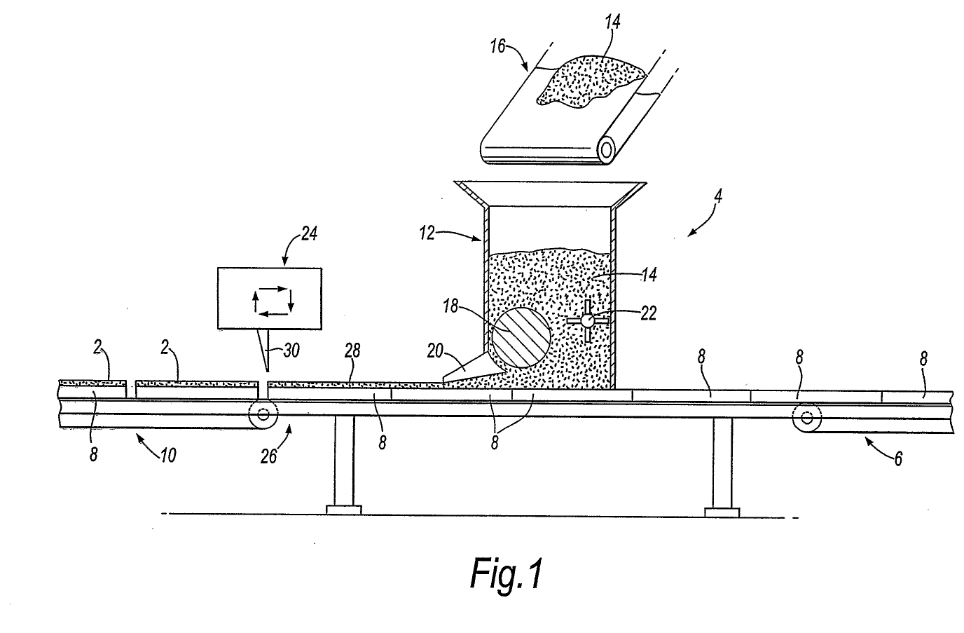

FIG. 1 is a diagrammatic side elevation, partly in section of a roof tile-making machine;

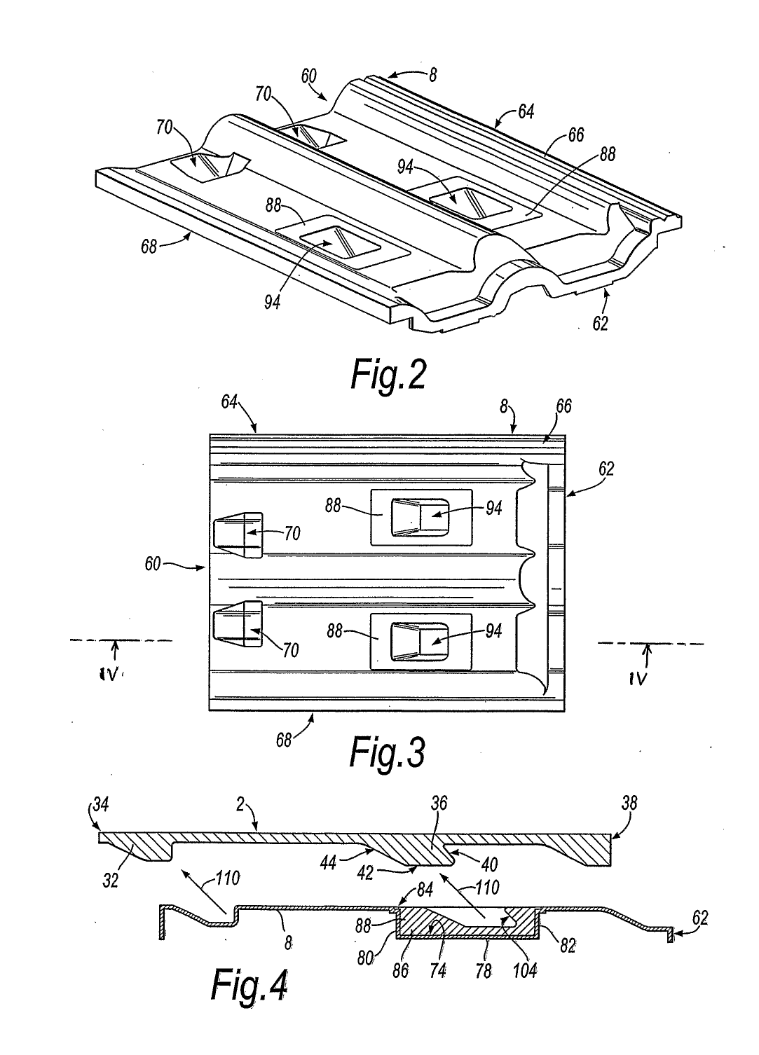

FIG. 2 is an upper left-hand perspective view of a roof tile pallet provided by the invention;

FIG. 3 is a plan view of the tile pallet of FIG. 2;

FIG. 4 is a section view as seen along the line IV-IV of FIG. 3 including a diagrammatic representation of a de-moulded roof tile:

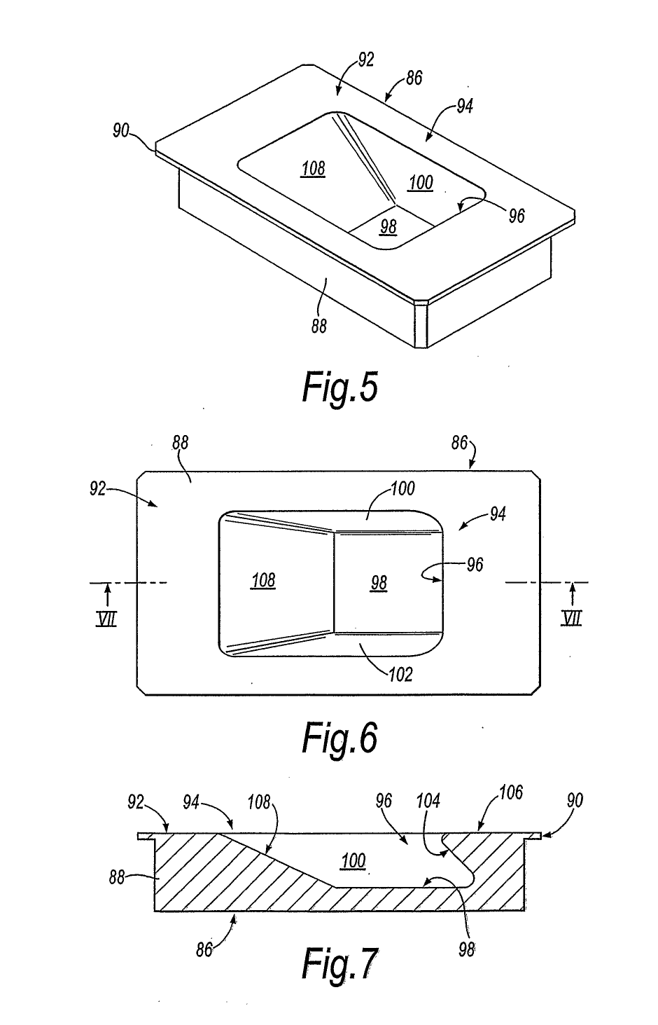

FIG. 5 is an upper left-hand perspective view of an insert for the pallet of FIGS. 2, 3 and 4;

FIG. 6 is a plan view of the insert of FIG. 5;

FIG. 7 is a section along the line VII-VII of FIG. 6;

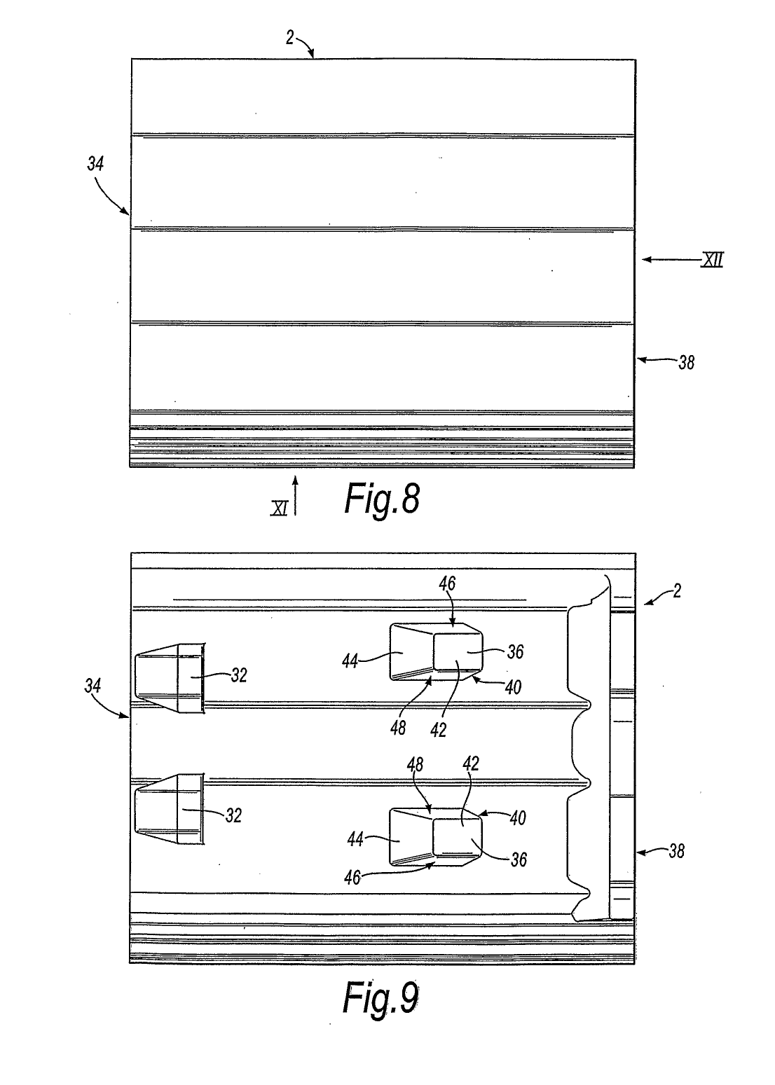

FIG. 8 is a plan view of a roof tile provided by the present invention;

FIG. 9 is an underside view of the roof tile shown in FIG. 8;

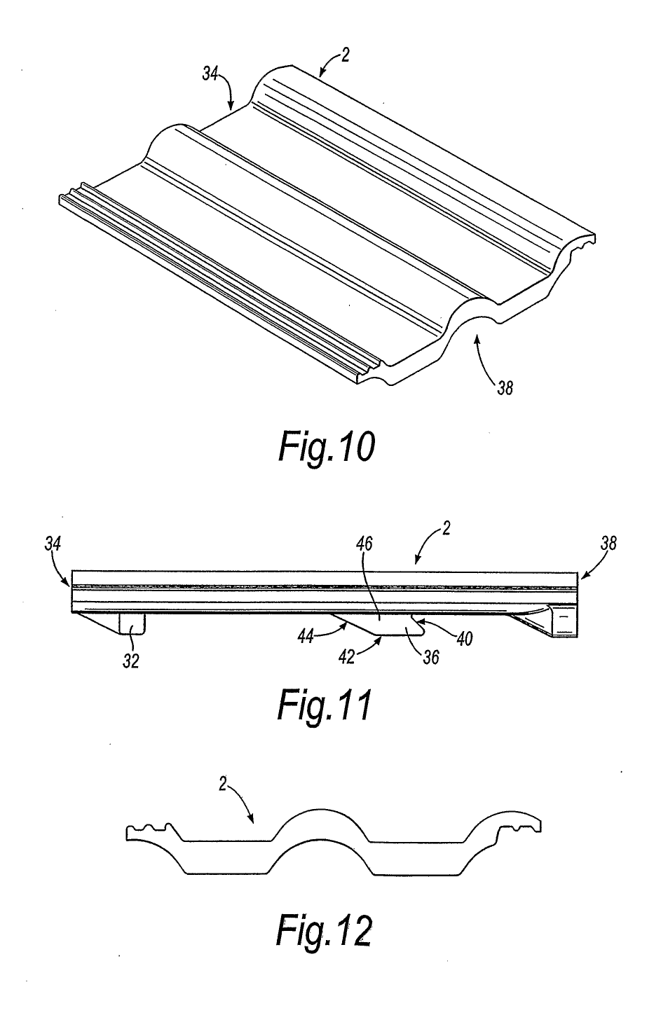

FIG. 10 is a left-hand upper perspective view of the roof tile shown in FIG. 8;

FIG. 11 is a view in the direction of the arrow XI in FIG. 8;

FIG. 12 is a view in the direction of the arrow XII in FIG. 8,

FIG. 13 is a plan view of a tile pallet according to an alternative embodiment of the invention;

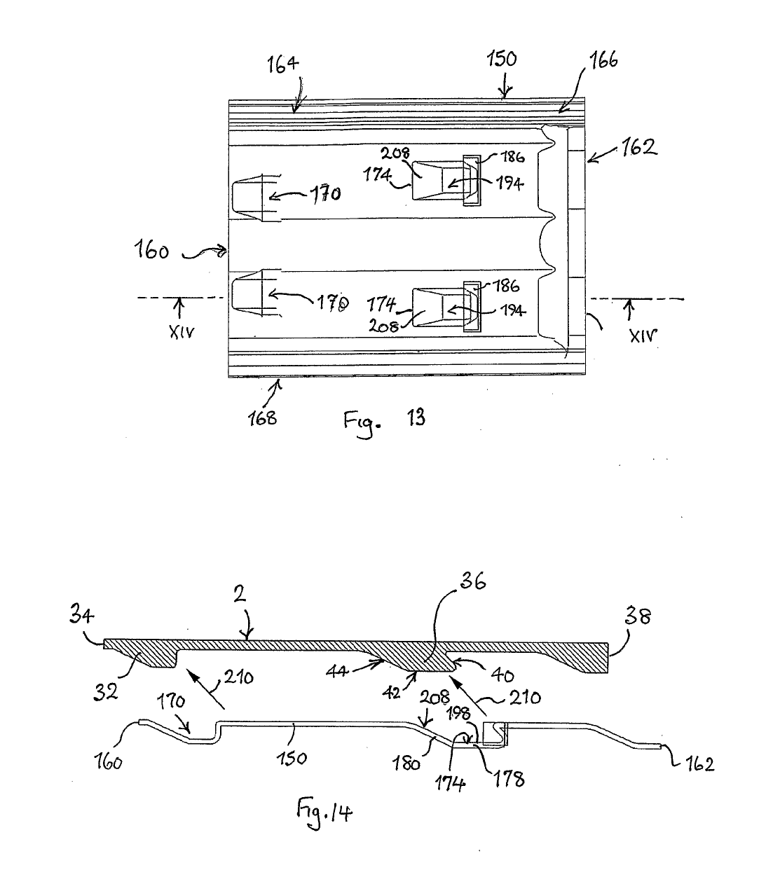

FIG. 14 is a section view as seen along the line XIV-XIV of FIG. 13 including a diagrammatic representation of a de-moulded roof tile:

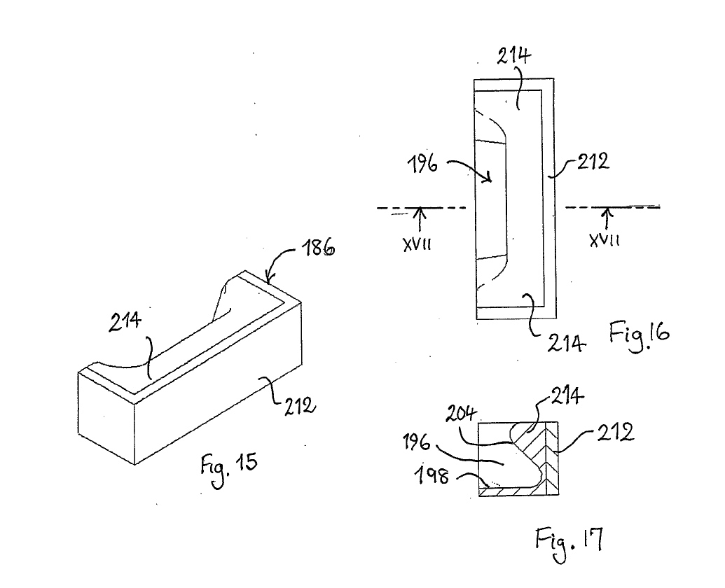

FIG. 15 is an upper left-hand perspective view of an insert for the pallet of FIGS. 13 and 14;

FIG. 16 is a plan view of the insert of FIG. 15; and

FIG. 17 is a section along the line XVII-XVII of FIG. 16;

In a first example of the invention, the building product is a concrete roof tile 2 that is manufactured in a conventional concrete roof tile making plant, which includes a make section 4 shown diagrammatically in FIG. 1.

The make section 4 lies between an in-feed conveyor 6 for tile pallets 8 fed seriatim toward the make section 4 and an out-feed conveyor 10 of the tile making plant for feeding pallets 8 with green-state roof tiles 2 to a curing chamber, not shown.

The make section 4 comprises a pallet feed mechanism, not shown, by which the pallets 8 are conveyed through the make section 4. The make section also comprises a hopper 12 for receiving concrete tile mortar 14 from an overhead conveyor 16, a roller 18, a slipper 20 downstream of the roller 18 and a tined roller 22 upstream of the roller 18, see FIG. 1.

Downstream of the hopper 12, the make section is provided with a reciprocating knife mechanism 24 overlying a downstream end 26 of the make section 4.

From the above, it will be readily appreciated that concrete roof tiles are formed by feeding tile pallets 8 seriatim to the make section 4 whereat concrete tile mortar 14 fed into the hopper 12 from the overhead conveyor 16 is compacted onto successive pallets 8 by the tined roller 22, the roller 18 and the slipper 20 to form a ribbon of extrudate 28 overlying the pallets 8.

The ribbon of extrudate 28 is thereafter cut by a knife 30 of the reciprocating knife mechanism 24 to form discrete green-state roof tiles on their associated pallets 8, see FIG. 1. The pallets 8 and the green-state tiles are thereafter conveyed to a curing chamber, not shown, where the roof tiles are subjected to an atmosphere of appropriate temperature and humidity for a period of time commensurate with achieving sufficient strength for enabling the eventual de-moulding of the roof tiles from the pallets 8.

Because the underside of conventional tiles only includes hanging nibs that are designed to be demoulded, it is simply a matter of effecting upward movement between the tile pallets 8 and the green-state tiles. The green-state roof tiles are then packaged for distribution while the pallets 8 are returned to the make section 4 for a subsequent tile making operation.

However the concrete roof tile 2 of the present invention is not so configured in that, while it is generally configured as a conventional, interlocking ‘Bold Roll’ roof tile and is provided with two conventional hanging nibs 32 at a head portion 34 thereof, it is also provided with two integral hook-like protuberances 36 positioned approximately one-third of the length of the tile from a tail end 38 thereof.

The hook-like protuberances 36 each comprise a re-entrant front surface 40, an under surface 42, a sloping rear surface 44 and converging opposite side faces 46 and 48, see FIGS. 4, 9 and 11.

The hook-like protuberances 36 each comprise a re-entrant wall surface 40 that is formed at an appropriate angle for engagement, in use, with a like re-entrant surface formed on a roof panel or the like, for attachment of the roof tile 2 to a roof structure.

From FIGS. 4 and 11, it will be seen that the hook-like protuberances 36 are substantially of trapezium shape in sideways cross-section. That is, the under surface 42 of each protuberance 36 is substantially parallel to the under surface of the tile, while the re-entrant front surface 40 and the sloping rear surface 44 converge in the direction away from the tile. This configuration facilitates the attachment of the roof tiles 2 to a roof structure, in use, and the separation of the roof tiles 2 from their respective pallets 8 as hereinafter described.

The roof tile pallet 8, which is intended for use in forming an underside of a so called ‘Bold Roll’ roof tile 2, is provided by an aluminium casting of thin cross-section, see FIG. 4.

The roof tile pallet 8 comprises a head portion 60, a tail end portion 62 and a first side edge 64, including an upwardly facing channel portion 66. The channel portion 66 is for forming, in use, an over-lock on the roof tile 2, the pallet 8 also comprising a second side edge 68, see FIGS. 2 and 3, above which an under-lock is formed in the make section 4.

At its head portion 60, the pallet 8 is provided with two recesses 70 for forming, in use, the hanging nibs 32 of the concrete roof tile 2, see FIGS. 4, 9 and 11.

The roof tile pallet 8 also comprises two further recesses 74 spaced approximately one-third of the pallet length from the tail end portion 62 thereof, see FIG. 4. The recesses 74 are identical, both being rectangular in plan and having a lower wall 78, end walls 80 and 82, see FIG. 4, and opposite side walls not shown.

The recesses 74 each further comprise a stepped mouth portion 84, see FIG. 4, the purpose of which will be made clear hereinafter.

The recesses 74 are each adapted to receive an associated insert 86 respectively, which inserts 86 are moulded from a rubberised plastic composition or a like material.

The inserts 86 each comprise a body 88 provided with a peripheral flange 90 extending around an upper surface portion 92 thereof, see especially FIGS. 5 to 7, the peripheral flange 90 being accommodated, in use, in the stepped mouth portion 84 of the roof pallet 8, see particularly FIG. 4.

Each insert 86 comprises a recess 94, which is configured as a raked re-entrant cavity 96 of substantially trapezium shape in side-ways cross-section as viewed in FIG. 4. The re-entrant cavities 96 each comprise a floor surface 98, opposite side wall surfaces 100 and 102, a re-entrant wall surface 104 at an end 106 nearest the tail end 62 of the pallet 8, in use, see FIGS. 4 and 7. Also the re-entrant cavities 96 each comprise a downward sloping surface 108, see FIGS. 2, 3 and 4. The re-entrant wall surface 104 and the downward sloping surface 108 converge in the direction of the cavity floor surface 98 to facilitate, in use, the de-moulding of a concrete roof tile 2 as hereinafter described.

When used for the production of concrete roof tiles 2 by the roller and slipper extrusion method, roof tile pallets 8 are fed seriatim through the make section 4 of the concrete roof tile plant and concrete mortar 14 is fed via the hopper 12 onto the pallets 8 to form a ribbon 28 of extrudate overlying a succession of pallets 8 as they pass beneath the roller 18 and slipper 20 of the make section 4, see FIG. 1.

When the concrete roof tile mortar 14 is fed via the hopper 12 of the make section 4, in addition to forming a ribbon of mortar on the succession of pallets 8, the recesses 70 are filled with mortar to form the hanging nibs 32 of the roof tiles 2 while the re-entrant cavities 96 are filled with mortar to form the hook-like protuberances 36 on each roof tile 2, see FIG. 4.

As stated above, the ribbon 28 of extrudate, so formed, is cut by the knife 30 of the reciprocating knife mechanism 24 to form discrete green state roof tiles 2 on their respective pallets 8. Then, after being cured, the roof tiles 2 are separated from their pallets 8 in a de-moulding device, not shown, wherein the cured roof tiles 2 are caused to be moved in the direction of the arrows 110 generally as shown diagrammatically in FIG. 4, according to the method hereinafter described.

The tile on its pallet is presented to a conventional depalleter (not shown). The depalleting discs engage the pallets on their side edges 64 and 68, thus breaking the bond between the tile and pallet. For tiles without the hook-like protuberances 36, the tile simply lifts off the pallet and is conveyed on its own conveyor to be packaged whilst the pallet, on a separate conveyor, is returned to the tile machine for re-use. In the case of tiles according to the invention, the tile is moved in the direction of arrow 110 to permit its separation from the pallet. The resilience of the insert 86 allows the hook-like protuberances 36 to be removed from the recess 94 without them being damaged. The tiles 2 are thereafter packaged for storage prior to despatch to an end user while the pallets 8 are conveyed once again to the make section 4 of the roof tile plant.

Turning now to the embodiment of the invention shown in FIGS. 13 to 17, from FIG. 14 it will be seen that the roof tile pallet 150, which is intended for use in forming an underside of the same or similar roof tile 2, is provided by an aluminium casting of thin cross-section.

The roof tile pallet 150 comprises a head portion 160, a tail end portion 162 and a first side edge 164, including an upwardly facing channel portion 166. The channel portion 166 is for forming, in use, an under-lock on the roof tile 2, the pallet 150 also comprising a second side edge 168.

At its head portion 160, the pallet 150 is provided with two recesses 170 for forming, in use, the hanging nibs 32 of the concrete roof tile 2.

The roof tile pallet 150 also comprises two further recesses 174 spaced approximately one-third of the pallet length from a tail end portion 162 thereof. The recesses 174 are identical, both being T-shaped in plan and having a lower wall 178, end walls and opposite side walls. Also the recesses 174 each comprise a downward sloping surface 208. The recesses 174 are each adapted to receive, in the cross portion of their T-shape, an associated insert 186 respectively.

In the illustrated embodiment, the inserts 186 comprise a U-shaped aluminium backing member 212 to which is bonded a resilient plastics lip member 214. The lip member 214, together with the walls of the recess 174, defines a raked re-entrant cavity 196 of substantially trapezium shape in side-ways cross-section as viewed in FIG. 14, having a re-entrant wall surface 204 at an end nearest the tail end 162 of the pallet 150, in use and a floor surface 198. The re-entrant wall surface 204 and the downward sloping surface 208 converge in the direction of the cavity floor surface 198 to facilitate, in use, the de-moulding of a concrete roof tile 2 as hereinafter described.

When the concrete roof tile mortar 14 is fed via the hopper 12 of the make section 4, in addition to forming a ribbon of mortar on the succession of pallets 8, the recesses 170 are filled with mortar to form the hanging nibs 32 of the roof tiles 2 while the recesses 174, together with their re-entrant cavities 196, are filled with mortar to form the hook-like protuberances 36 on each roof tile 2.

After being cured, the roof tiles 2 are separated from their pallets 150 in a de-moulding device, not shown, wherein the cured roof tiles 2 are caused to be moved in the direction of the arrows 210 as shown diagrammatically in FIG. 14.

It will be appreciated that the pallets 8 used for the manufacture of ‘Bold Roll’ concrete roof tiles can be replicated to make tiles of any shape including flat interlocking tiles and plain tiles.

It will be appreciated that the pallets 8 used for the manufacture of concrete roof tiles can be replicated for use in a clay tile press for the manufacture of clay roof tiles.

It will also be appreciated that the pallets used for the manufacture of concrete roof tiles can be replicated as a half mould of a pair of half-moulds for use in the manufacture of cast concrete roof tiles from a castable, cementitious composition.

Modification of the pallets may also be made within the scope of the present invention, for example, the pallets may be made from any suitable metal or plastic composition capable of withstanding the forces exerted on the pallets during an extrusion process, a casting process or a pressing operation used for forming the roof tiles.

In addition, the inserts used with the pallets may also be made from any suitable resilient material commensurate with moulding the hook-like protuberances from the composition used therefor and facilitating the de-moulding of the roof tiles while maintaining the integrity of the hook-like protuberances.

1. A method for the manufacture of a concrete roof tile by an extrusion process comprising:
(a) providing a rigid tile pallet with a re-entrant cavity;
(b) passing the tile pallet beneath a hopper containing a moldable cementitious composition, the hopper being provided with a roller and slipper for generating the upper surface, in use, of the roof tile,
(c) feeding the cementitious composition onto the tile pallet as the tile pallet passes beneath the hopper to fill the re-entrant cavity of the tile pallet with the cementitious composition;
(d) allowing the moldable material to set to form a concrete roof tile having a hook-like protuberance on the underside, in use, of the roof tile to facilitate, in use, the attachment of the concrete roof tile to the structure of a building; and
(e) removing the concrete roof tile from the tile pallet, characterised by the re-entrant cavity having a resilient portion to facilitate the removal of the concrete roof tile without detrimental effect to the hook-like protuberance.

2. (canceled)

3. A method according to claim 1, wherein the cementitious composition is a concrete mortar.

4. (canceled)

5. A method according to claim 1, wherein the rigid tile pallet comprises two half-molds, wherein a respective one of the half-molds forming an underside of the concrete roof tile is provided with said re-entrant cavity for forming, in use, the hook-like protuberance on the underside of the roof tile.

6. A tile pallet for the production of a concrete roof tile, the tile pallet comprising at least one re-entrant cavity for forming a hook-like protuberance on the concrete roof tile, the re-entrant cavity having a resilient portion to facilitate the removal of the concrete roof tile from the tile pallet without detrimental effect to the hook-like protuberance.

7. A tile pallet according to claim 6, wherein said resilient portion is in the form of an insert which defines said re-entrant cavity.

8. A tile pallet according to claim 7, comprising two half-molds, wherein the resilient portion is provided by a rectangular insert for insertion into a complementarily shaped aperture in a respective one of said molds, the insert being provided with a peripheral flange to prevent displacement of the insert relative to the tile pallet when in use in forming said hook-shaped protuberance.

9. A tile pallet according to claim 6, wherein said resilient portion forms a part of said re-entrant cavity.

10. A tile pallet according to claim 9, wherein said resilient portion forms a rear lip of said re-entrant cavity.

11. A tile pallet according to claim 10, wherein the resilient portion is provided by an insert for insertion into a complementarily shaped aperture in the tile pallet.

12. A tile pallet according to claim 11, wherein the insert comprises a rigid backing member supporting said resilient portion.

13. A tile pallet according to claim 6, wherein the resilient portion is made from a flexible natural or synthetic material, such as rubber.

14. A tile pallet according to claim 6, wherein the re-entrant cavity is provided towards an end thereof that is a lower end, in use, of the concrete roof tile.

15. A tile pallet according to claim 6, wherein the re-entrant cavity is of substantially trapezium shape in sideways cross-section to further facilitate the ease with which a molded concrete roof tile is removed from the tile pallet.

16. A tile pallet according to claim 6, wherein said re-entrant cavity is raked to further facilitate the removal of the concrete roof tile without detrimental effect to the hook-like protuberance.

17. (canceled)

18. A tile pallet according to claim 6, comprising at least two said re-entrant cavities for the formation of at least two said hook-like protuberances on each concrete roof tile.

19. A tile pallet according to claim 12, wherein said rigid backing member is an integral part of the tile pallet.

20. A tile pallet according to claim 12, wherein said rigid backing member is separate from the tile pallet.

21. A tile pallet according to claim 9, wherein the resilient portion is provided by an insert for insertion into a complementarily shaped aperture in the tile pallet.

22. A tile pallet according to claim 21, wherein the insert comprises a rigid backing member supporting said resilient portion.
